(19) United States
(12) Patent Application Publication
(10) Pub. No.: US 2006/0203502 A1
(43) Pub. Date: Sep. 14, 2006

(54) Total internal reflection license plate frame

(76) Inventors: Peter Morris Stevens, Salt Lake City, UT (US); John Colin Stevens, Salt Lake City, UT (US); Stephen John Hart, San Juan Capistrano, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/367,086

(22) Filed: Mar. 2, 2006

Related U.S. Application Data
(60) Provisional application No. 60/660,168, filed on Mar. 10, 2005.

(51) Int. Cl. F21V 9/00

(52) U.S. Cl. 362/497; 362/511

(57) ABSTRACT

A license plate frame has a pattern formed on a first side. At least one light source is embedded within the license plate frame. A power source is connected to the light source. Light emitted by the light source only escapes from the pattern.

This application claims priority to U.S. Provisional Application No. 60/660,168, filed Mar. 10, 2005, and titled TOTAL INTERNAL REFLECTION LICENSE PLATE FRAME, which is incorporated by reference in its entirety.

### BACKGROUND

1. Field

The embodiments relate to license plate frames, and more particularly to license plate frames with an embedded light source that is patterned on a first side where light from the light source only escapes through the pattern.

2. Description of the Related Art

Standard license plate frames are typically made of opaque plastic or metal. License plate frames secure a license plate to a vehicle. Some license plate frames are adorned with writing or artwork on the perimeter of the frame. Some license plate frames have light sources that are attached externally to the license plate frame.

U.S. Pat. No. 1,887,087 issued to Fizner discloses an external light source that attaches to a license plate to illuminate the frame and to light up when a vehicle is braking.

U.S. Pat. No. 6.550,166 B1 issued to Lyon discloses a license plate frame with a cover.

U.S. Pat. No. 6,243,977B1 issued to Shuen discloses a knockdown license plate frame.

U.S. Pat. No. 6,553,695B1 issued to Wang discloses a license plate frame with attached emblems.

U.S. Pat. No. 6,570,674B2 issued to Pleotis discloses a device for engraving license plate frames.

U.S. Publication No. 20050005484 submitted by Simonazzi discloses a license plate frame with supports for sensing devices.

U.S. Pat. No. 6,526,680 issued to Yu discloses a license plate frame having LEDs mounted on its perimeter and are attached to running lights and brake lights.

U.S. Pat. No. 6,478,458 issued to Hickman discloses a motorcycle license plate frame that has LEDs attached on the front and a cover that fits over the LEDs with a message that is formed on the cover from transparent apertures.

U.S. Pat. No. 5,150,961 issued to Gonzalez discloses a license plate frame that houses a neon light. U.S. Pat. Nos. 5,255,166 and 5,192,125 are continuations of U.S. Pat. No. 5,150,961.

U.S. Pat. No. 5,029,053 issued to Solow discloses light sources disposed in a hollowed out portion of a frame that emit a light glow through an outer portion of the frame. U.S. Pat. No. 4,857,890 issued to Solow discloses light bulbs attached to a license plate frame. The light bulbs are connected to the running lights and brake lights.

### SUMMARY

One embodiment includes a license plate frame having a pattern formed on a first side. At least one light source is embedded within the license plate frame. A power source is connected to the light source. Light emitted by the light source only escapes from the pattern.

Another embodiment includes a license plate frame having a pattern formed on a first side. A plurality of light sources are disposed within the license plate frame. A power source is coupled to the plurality of light sources. Light emitted by the plurality of light sources is only emitted through the pattern.

Yet another embodiment comprises forming a license plate frame with an embedded light source, forming a pattern on a first side of the license plate frame to act as a waveguide, and attaching a power source coupling to the embedded light source. Light emitted from the embedded light source only escapes through the pattern.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 is a top view of one embodiment of a rectangular acrylic license plate holder;

FIG. 2 is a view of an embodiment illustrating lettering and lighting by light emitting diodes (LEDs) embedded in the perimeter of the license plate holder; and

FIG. 3 illustrates an embodiment showing structure layout and relationship.

### DETAILED DESCRIPTION

The embodiments discussed herein generally relate to internal lighted license plate frames. Referring to the figures, exemplary embodiments will now be described. The exemplary embodiments are provided to illustrate the embodiments and should not be construed as limiting the scope of the embodiments.

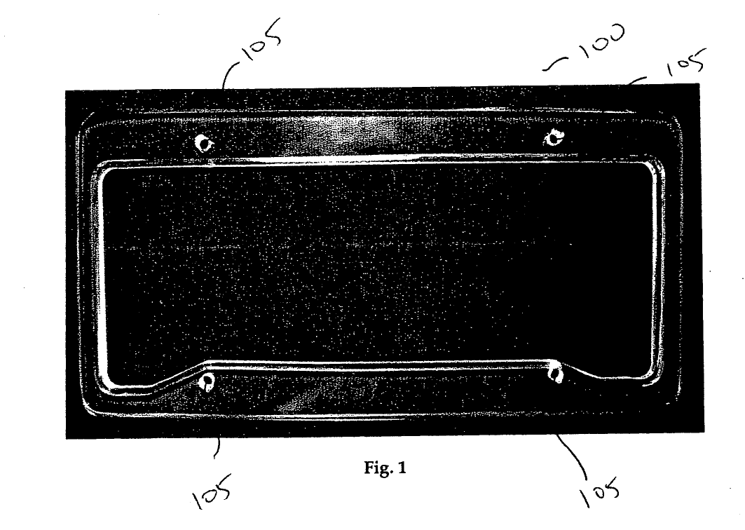

FIG. 1 illustrates an embodiment of a rectangular license plate holder, fabricated from acrylic or similar clear plastic. License plate holder 100 includes holes 105 to permit fastening to a vehicle. The smooth surfaces of the plate holder creates the T.I.R. or total internal reflection environment, trapping light emitted from a source, such as light emitting diodes (LEDs, ultraviolet (UV), RGB (red-green-blue), neon laser, or any combination of the aforementioned sources).

License plate holder 100 uses T.I.R. of light emitted by one or more of a variety of kinds of small light sources embedded into the frame of license plate holder 100 fabricated out of acrylic or similar transparent material. The surface of license plate holder 100 is patterned locally to permit the exit of light by a variety of techniques including, but not limited to: laser etching, chemical etching, mechanical abrasion, molding, and embossing of diffusive scattering areas, macroscopic optical structures, diffraction gratings, and molded lenslet arrays.

By using one or more of these or similar techniques to roughen or otherwise shape or modify the surface, printed material or mottos, and artwork including logos, are applied. The roughened, shaped, or modified surface permits coupling out (escape) of the light which would otherwise remain trapped within the frame. The light may be directed to achieve a variety of effects. The frame has holes to permit it to be bolted to a vehicle, thus securing a license plate.

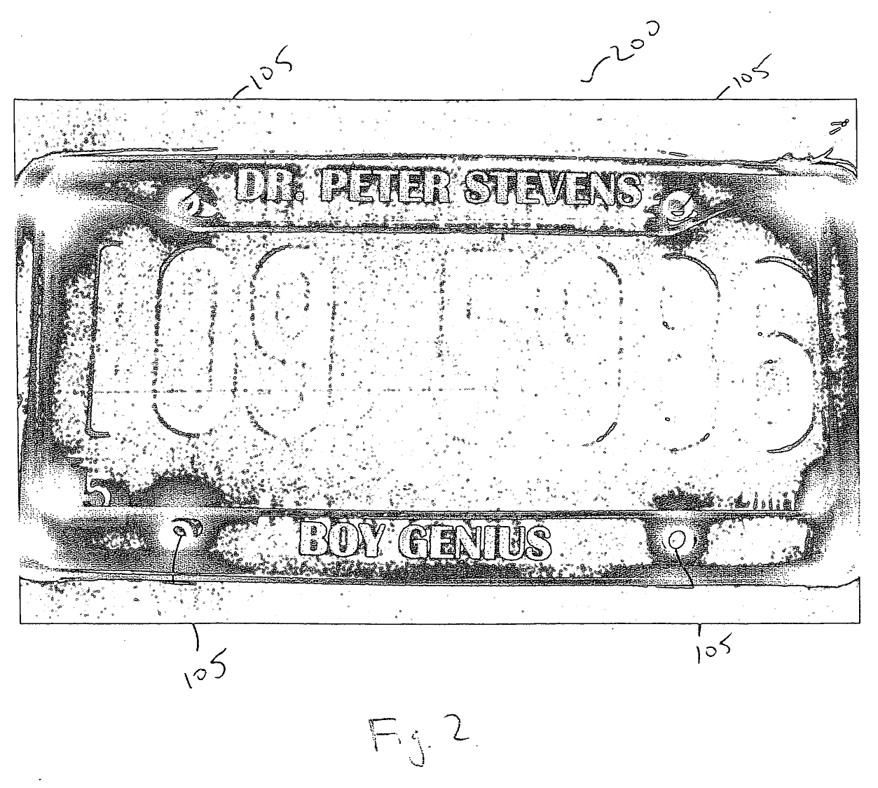

FIG. 2 illustrates license plate holder 200 including light sources and wording. A variety of light sources can be embedded into license plate holder 200 in order to generate the illumination. These include, but are not limited to: LEDs (white or single color), UV, RGB, neon, laser, etc. In one embodiment the lights are powered by 9 or 12 volt (or other) batteries or by the vehicular battery. The lighting color, intensity, and timing (intermittent vs. continuous) can be controlled by rheostat, ambient light, sound sensor, computer, or manually.

In one embodiment mirror or opaque coatings are placed on the frame to reflect the lettering or artwork and to retain light within the wave guide.

In one embodiment phosphor or fluorescent material can be added to the roughened or modified area to alter the spectral characteristics of the illumination.

In one embodiment customized lettering, logos, or artwork are roughened onto or created upon the inner surface by one or more techniques described above. It is the roughened or structured surface that serves as an interruption in the wave guide and permits coupling out of the otherwise trapped light. This is what forms or illuminates the text and artwork.

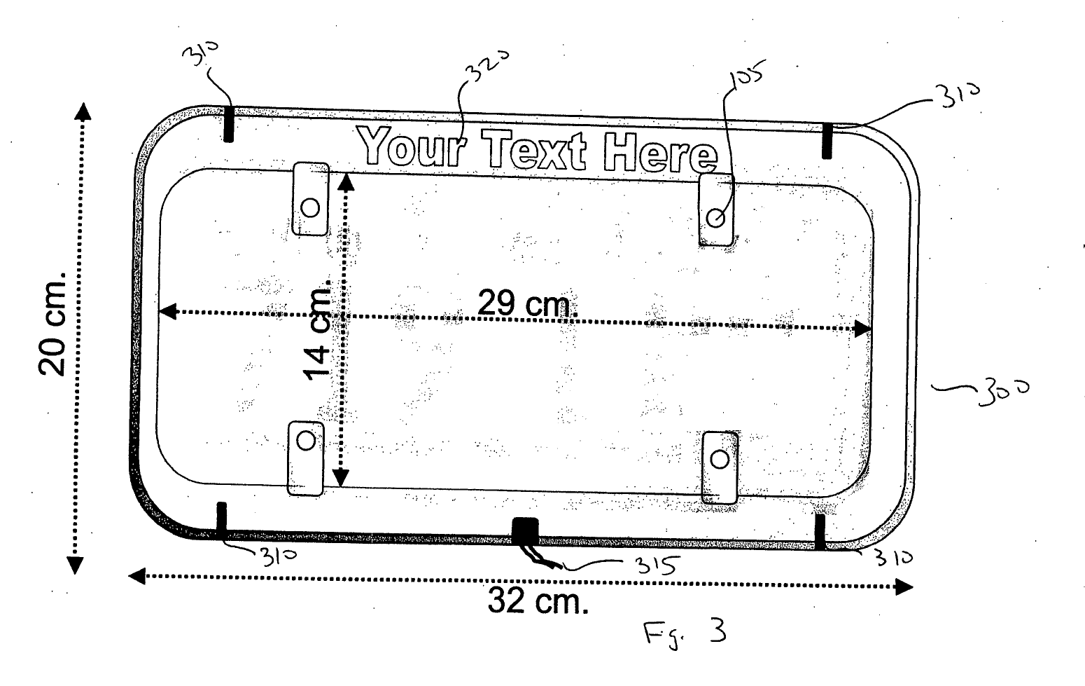

FIG. 3 illustrates license plate holder 300. Light sources 310, such as LEDs, lasers or lamps, are embedded around the perimeter of the plate holder. In one embodiment, four (4) light sources are embedded. In other embodiments, other numbers of light sources can be embedded, such as one (1), two (2), three (3), etc. Embedded lights 310 are powered by either separate batteries, such as 9 or 12 volt, solar cells, or by the vehicular battery itself. Wire coupler 315 carries the power to light sources 310.

Standard license plate holders are typically made out of opaque plastic or metal and may or may not feature external lights or printed or embossed information or decoration pertaining to, for example, the motor vehicle dealer, the community, a given business or school, or the state. T.I.R. license plate holder 300 is constructed of transparent acrylic or similar material and takes advantage of its intrinsic qualities as an optical wave guide. Light sources 310 are embedded into the material. In one embodiment light sources 310 have controlled intensity, timing and color. The printed information 320, motto, company logo, or similar information is high-lighted by locally coupling the light out of the wave guide.

In one embodiment the total internal reflection and optical transmission qualities of Acrylic (or similar material) is combined with embedded light sources to illuminate surface images including, but not restricted to, printing or artwork on a unique license plate holder. This would be for use on any motor vehicle including, but not limited to: automobiles, limousines, buses, trucks, motor homes, motorcycles, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. An apparatus comprising:
a license plate frame having a pattern formed on a first side;
at least one light source, the at least one light source embedded within the license plate frame; and
a power source coupled to the at least one light source,
wherein light emitted by the at least one light source only escapes from the pattern.

2. The apparatus of claim 1, further comprising
a rheostat coupled to the power source, the rheostat operates to control light intensity of the at least one light source.

3. The apparatus of claim 1, further comprising:
a light sensor to sense ambient light, wherein the light sensor controls light intensity of the at least one light source.

4. The apparatus of claim 1, further comprising:
one of a sound sensor and a computer to control light emission of the at least one light source, wherein the light emission is one of intermittent and continuous.

5. The apparatus of claim 1, wherein the license plate frame is made of acrylic.

6. The apparatus of claim 1, wherein the license plate frame is adapted to couple to one of an automobile and a motorcycle.

7. The apparatus of claim 1, wherein the at least one light source is one of a light emitting diode (LED), an ultraviolet (UV) source, a neon light and an optical laser.

8. The apparatus of claim 1, the license plate frame further including a plurality of through holes.

9. The apparatus of claim 1, wherein the pattern operates as a waveguide.

10. An apparatus comprising:
a license plate frame having a pattern formed on a first side;
a plurality of light sources, the plurality of light sources disposed within the license plate frame; and
a power source coupled to the plurality of light sources,
wherein light emitted by the plurality of light sources is only emitted through the pattern.

11. The apparatus of claim 10, further comprising
a rheostat coupled to the power source, the rheostat operates to control light intensity of the at least one light source.

12. The apparatus of claim 10, further comprising:
a light sensor to sense ambient light, wherein the light sensor controls light intensity of the at least one light source.

13. The apparatus of claim 10, further comprising:
one of a sound sensor and a computer to control light emission of the at least one light source, wherein the light emission is one of intermittent and continuous.

14. The apparatus of claim 10, wherein the plurality of light sources is one of a light emitting diodes (LEDs), ultraviolet (UV) sources, neon light sources and optical lasers.

15. The apparatus of claim 10, wherein the pattern operates as a waveguide.

16. A method comprising:
forming a license plate frame with at least one embedded light source;
forming a pattern on a first side of the license plate frame to act as a waveguide; and
attaching a power source coupling to the embedded light source, wherein light emitted from the embedded light source only escapes through the pattern.

17. The method of claim 16, wherein the pattern is formed by one of laser etching, chemical etching, mechanical abrasion, molding, and embossing of diffusive scattering areas.

18. The method of claim 16, wherein the pattern is formed by one of applying macroscopic optical structures to the first side, attaching diffraction gratings to the first side, and molding lenslet arrays on the first side.

19. The method of claim 16, further comprising
attaching a rheostat to the power source coupling, the rheostat operates to control light intensity of the embedded light source.

20. The method of claim 16, further comprising:
attaching a light sensor to the power source coupling, the light sensor to sense ambient light, wherein the light sensor controls light intensity of the embedded light source.

21. The method of claim 16, further comprising:
attaching one of a sound sensor and a computer to the power source coupling to control light emission of the embedded light source, wherein the light emission is one of intermittent and continuous.

22. The method of claim 16, further comprising:
applying one of a mirror coating and an opaque coating to the first side to reflect the pattern and to retain light within the license plate frame.

23. The method of claim 16, further comprising:
applying one of a phosphor material and a fluorescent material to the pattern to alter spectral characteristics of illumination of the emitted light.
